(19) United States
(12) Patent Application Publication
(10) Pub. No.: US 2019/0212962 A1
(43) Pub. Date: Jul. 11, 2019

(54) DISPLAY DEVICE AND DISPLAY SYSTEM

(71) Applicant: KYOCERA Document Solutions Inc., Osaka (JP)

(72) Inventor: Shogo IWASAKI, Osaka (JP)

(73) Assignee: KYOCERA Document Solutions Inc., Osaka (JP)

(21) Appl. No.: 16/325,511

(22) PCT Filed: Jun. 21, 2018
(86) PCT No.: PCT/JP2018/023603

§ 371 Date: Feb. 21, 2019

(30) Foreign Application Priority Data
Jul. 14, 2017 (JP) 2017-138025

(51) Int. Cl. G06F 3/12; G06F 3/01; G06T 19/00; G06T 7/73

(52) U.S. Cl. CPC G06F 3/1259; G06F 3/1207; G06T 7/73; G06T 19/006; G06T 19/003; G06F 3/017

(57) ABSTRACT

A display device (1) includes a display part (11) for, while allowing a user to discern a real space, displaying in overlay a virtual image forming apparatus (40) on the real space; and a controller (14) for controlling the display part (11). Upon accepting from the user an operation request of requesting an operation for the virtual image forming apparatus (40), the controller (14) instructs the display part (11) to change a status of the virtual image forming apparatus (40) to a status resulting when the operation requested by the operation request is executed.

### TECHNICAL FIELD

The present invention relates to a display device and a display system.

### BACKGROUND ART

Conventionally, there is known a display device for displaying a virtual operation panel that simulates an operation panel of an image forming apparatus. Such a display device is disclosed in PTL 1 as an example.

The display device of PTL 1 is communicatably connected to an image forming apparatus, and upon detecting an operation for the virtual operation panel, transmits operation information indicative of the detected operation to the image forming apparatus. The image forming apparatus, upon receiving the operation information from the display device, executes a process corresponding to the operation indicated by the received operation information.

### LIST OF CITATIONS

### Patent Literature

PTL 1: JP 2016-207048 A

### SUMMARY OF THE INVENTION

### Problem to be Solved by the Invention

For example, when an explanation on an image forming apparatus is given to users of the image forming apparatus (including persons who intend to purchase the image forming apparatus or other persons), it is preferable that the users are allowed to operate a real machine. This is because the users' operating the real machine in the course of explanation of the image forming apparatus allows the explanation on the image forming apparatus to be fulfilled with higher efficiency.

However, in some demonstration sites prepared for the explanation, the real machine cannot be carried into the demonstration site. Since the users' operating the real machine is infeasible in this case, there can arise a disadvantage that the users cannot sufficiently understand contents of the explanation given by an explainer.

Under such circumstances, in PTL 1, a virtual operation panel is displayed on a display device. However, even with an operation made for the virtual operation panel, given that the real machine is absent, a user would be unable to know how the real machine is changed in status by the operation. Accordingly, even with use of the display device of PTL 1, there can arise a disadvantage that the users cannot sufficiently understand contents of the explanation given by the explainer.

The present invention, having been accomplished to solve these and other problems, has an objective of providing a display device, as well as a display system, capable of efficiently fulfilling explanations as to an image forming apparatus even in the absence of the real machine.

### Solution to Problem

In order to achieve the above objective, in a first aspect of the invention, there is provided a display device including: a display part for, while allowing a user to discern a real space, displaying in overlay a virtual image forming apparatus on the real space; and a controller for controlling the display part. Upon accepting from the user an operation request of requesting an operation for the virtual image forming apparatus, the controller instructs the display part to change a status of the virtual image forming apparatus to a status resulting when the operation requested by the operation request is executed.

In a second aspect of the invention, there is provided a display system including a plurality of the display devices as described above, wherein when any one display device out of the plural display devices has accepted the operation request, the plural virtual image forming apparatuses change their statuses to a status resulting when an operation requested by the operation request is executed.

With the configuration of the invention, when the user has made an operation request, a status of the virtual image forming apparatus is changed to a status resulting when an operation requested by the operation request is executed. Thus, the user is allowed to know which status the real machine is thrown to by the operation requested by the operation request. Accordingly, on occasions when an explanation is performed on an image forming apparatus, the explanation on the image forming apparatus can be fulfilled with high efficiency even in the absence of the real machine. Advantageous Effects of the Invention

### Advantageous Effects of Invention

According to the present invention, explanations on an image forming apparatus can be fulfilled with high efficiency even in the absence of the real machine.

### BRIEF DESCRIPTION OF DRAWINGS

FIG. 1 is a diagram showing a configuration of a head mounted display as well as a display system equipped with the head mounted display according to one embodiment of the invention;

FIG. 2 is a flowchart showing a flow of AR display process to be performed by the head mounted display according to one embodiment of the invention;

FIG. 3 is a view showing a virtual image forming apparatus which is first displayed on the head mounted display according to one embodiment of the invention;

FIG. 4 is a view showing sight-line directions of head-mounted-display users according to one embodiment of the invention;

FIG. 5 is a view showing the virtual image forming apparatus to be displayed when a user of the head mounted display according to one embodiment of the invention has moved;

FIG. 6 is a view showing a display action to be performed when the head mounted display according to one embodiment of the invention has accepted a position-changing operation;

FIG. 7 is a view showing a display action to be performed when the head mounted display according to one embodiment of the invention has accepted an orientation-changing operation;

FIG. 8 is a view showing a display action to be performed when the head mounted display according to one embodiment of the invention has accepted a size-changing operation;

FIG. 9 is a flowchart showing a flow of AR display process to be performed by the head mounted display according to one embodiment of the invention;

FIG. 10 is a view showing a display action to be performed when the head mounted display according to one embodiment of the invention changes a status of the virtual image forming apparatus (a change to a job-executing status);

FIG. 11 is a view showing a display action to be performed when the head mounted display according to one embodiment of the invention changes the status of the virtual image forming apparatus (a change to the job-executing status);

FIG. 12 is a view showing a display action to be performed when the head mounted display according to one embodiment of the invention changes the status of the virtual image forming apparatus (a change to a cassette-pulled out status);

FIG. 13 is a view showing a display action to be performed when the head mounted display according to one embodiment of the invention changes the status of the virtual image forming apparatus (a change to a unit-opened status);

FIG. 14 is a view showing a display action to be performed when the head mounted display according to one embodiment of the invention displays a plurality of virtual image forming apparatuses;

FIG. 15 is a view showing a display action to be performed when the head mounted display according to one embodiment of the invention changes individual statuses of the plural virtual image forming apparatuses;

FIG. 16 is a view showing a display action to be performed when the head mounted display according to one embodiment of the invention performs to selectively change the status of any one of the plural virtual image forming apparatuses; and

FIG. 17 is a view showing a display action to be performed when the head mounted display according to one embodiment of the invention selectively changes the status of any one of the plural virtual image forming apparatuses (i.e., when having accepted an operation request related to scan function).

### DESCRIPTION OF EMBODIMENTS

### Configuration of Head Mounted Display

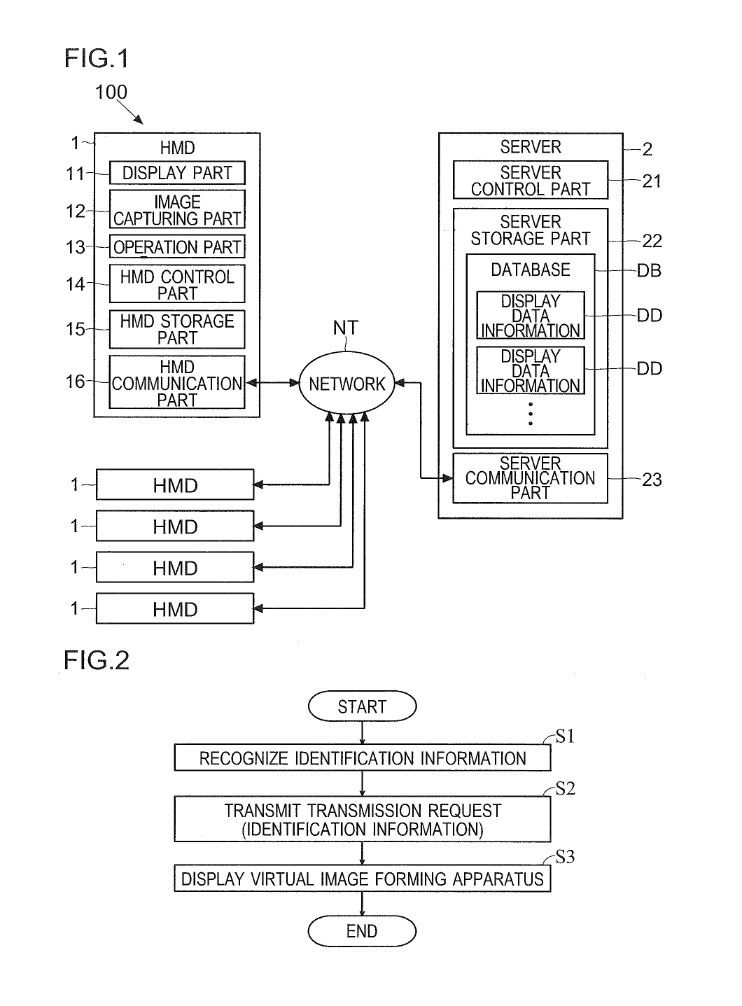

A head mounted display 1 according to this embodiment has a configuration as shown in FIG. 1. The head mounted display 1, being an eyeglass type, displays various images in parts corresponding to eyeglass lenses. Therefore, to a mounter (user) having the head mounted display 1 mounted thereon, it looks as if an image were displayed before the user's eyes. It is noted that the head mounted display 1 corresponds to ‘display device.’ Hereinafter, the term, head mounted display, will be abbreviated as HMD.

The HMD 1 includes a display part 11, an image capturing part 12, an operation part 13, an HMD control part 14, an HMD storage part 15, and an HMD communication part 16. These individual parts are mounted on an eyeglass-type frame.

The display part 11 serves for display. The display part 11 is placed at a position opposed to the eyes of the user having the HMD 1 mounted thereon. As a result, an image is displayed before the user's eyes. For example, a display unit of the optical transmission type (optically see-through type) that allows outdoor light to be transmitted therethrough is used as the display part 11. The display part 11, implemented by an optical transmission display unit, includes a half mirror so that an image to be displayed is reflected toward the user's eyes by the half mirror. In this case, outdoor light is transmitted by the half mirror so as to be incident on the user's eyes. That is, the display part 11, while allowing the user to discern the real space, displays an image in overlay on the real space. For the user, it looks as if the display image displayed by the display part 11 were synthesized in the real space (the display image is seen as overlaid on the real space).

The image capturing part 12 performs image capture. The image capturing part 12, including a CCD camera and the like, is placed at a position that enables image capture in a field-of-view direction of the user having the HMD 1 mounted thereon. As a result, a scene before the user's eyes (an object present in the real space spreading before the user's eyes) is captured as an image. When the user has made a gesture operation such as a hand (finger) motion before the user's eyes, the user's gesture operation is captured as an image. The image capturing part 12 outputs captured image data resulting from the image capture.

The operation part 13 accepts operations for making various types of settings related to display and image capture by the HMD 1 from the user having the HMD 1 mounted thereon. Hardware keys for accepting the operations, as an example, are provided in the HMD 1. In addition, a user's own PDA (Personal Digital Assistant), such as smartphone, tablet computer, and notebook-type personal computer, may be communicatably connected to the HMD 1 so that the PDA functions as the operation part 13.

The HMD control part 14 includes a CPU that operates based on control-dedicated programs and data. The HMD control part 14 executes various types of processes for controlling the HMD 1. For example, the HMD control part 14 controls display by the display part 11 and image capture by the image capturing part 12, individually. The HMD control part 14 also detects an operation that the operation part 13 (or PDA connected to the HMD 1) has accepted from the user.

The HMD storage part 15 includes nonvolatile memory (ROM) and volatile memory (RAM). The HMD storage part 15 stores therein control-dedicated programs and data for operating the HMD control part 14 (CPU). The HMD storage part 15 also stores therein data received from a later-described server 2 (e.g., display data for displaying an image).

The HMD communication part 16, including communication circuits and the like, is a communication interface for communicatably connecting the HMD 1 to external devices. The HMD control part 14 uses the HMD communication part 16 to communicate with external devices.

The HMD 1 (HMD communication part 16) is connected to a communication network NT such as Internet or LAN, as an example. A server 2 as an external device is also connected to the communication network NT. Then, the HMD 1 and the server 2 build up a display system 100.

The display system 100 may include a plurality of HMDs 1. In this case, the plural HMDs 1 are communicatably connected to other HMDs 1, respectively. Communications between the HMDs 1 may be performed either via the communication network NT or directly without intervention of the communication network NT. Numerical quantity of the HMDs 1 to be included in the display system 100 is not particularly limited, and may be either one or any plural number.

The server 2 includes a server control part 21, a server storage part 22, and a server communication part 23. The server 2 is managed by a manufacturer or distributor of an image forming apparatus (multifunction peripheral, printer, etc.). For example, a personal computer or the like may be used as the server 2.

The server control part 21 includes a CPU that operates based on control-dedicated programs and data. The server control part 21 executes various types of processes for controlling the server 2.

The server storage part 22 includes nonvolatile memory (ROM) and volatile memory (RAM). The server storage part 22 stores therein control-dedicated programs and data for operating the server control part 21 (CPU). The server storage part 22 further includes a mass storage device such as HDD.

The server communication part 23, including communication circuits and the like, is a communication interface for communicatably connecting the server 2 to external devices. The server control part 21 uses the server communication part 23 to access the communication network NT and perform communications with the HMDs 1 (data transmission and reception with the HMDs 1).

### AR Display Process

### Outline

The manufacturer or distributor of image forming apparatuses gives sales promotion or instructive training for usage to persons who intend to purchase an image forming apparatus. That is, the manufacturer or distributor provides explanations as to image forming apparatuses. On such occasions, the HMD 1 is provided to a purchase intender or a training attender (purchaser). The purchase intender or training attender has the HMD 1 mounted thereon. Thus, the purchase intender or training attender becomes a user of the HMD 1.

Sales promotion or instructive training for image forming apparatuses is carried out not by using a real image forming apparatus (real machine) but by using an AR (Augmented Reality) technique. With the intention of fulfilling sales promotion or instructive training by using the AR technique, display data of a virtual image forming apparatus (AR image to be displayed in overlay on the real space) are prepared beforehand. For example, apparatus statuses of the real machine are classified into plural categories, and plural display data corresponding to the plural apparatus statuses, respectively, are included in display data information DD. It is noted that the plural display data are each correspondingly associated with any one of later-described plural pieces of operation information. Also, identification information indicative of a corresponding real-machine apparatus type is added to the plural display data. Display data information DD including plural display data corresponding to one apparatus type is stored in a database DB. The database DB is stored in the server storage part 22.

In a case where plural apparatus types that can be an object of the sales promotion or instructive training are involved, display data of a virtual image forming apparatus are prepared for each of the apparatus types. Then, plural pieces of display data information DD corresponding to the plural apparatus types, respectively, are stored in the database DB. Hereinbelow, it is assumed that plural apparatus types that can be an object of the sales promotion or instructive training are involved in this case.

In a demonstration site where the sales promotion or instructive training is to be held, there exists a region where an AR marker is provided. The AR marker corresponds to ‘reference marker.’ For example, QR code (registered trademark) is used as the AR marker. Depending on the demonstration site used for the sales promotion or instructive training, it is allowable that the AR marker is printed on a recording medium (e.g., card) and the recording medium is distributed in the demonstration site.

When preparations for the sales promotion or instructive training are completed, a performer of the sales promotion or instructive training (an explainer who gives explanations as to the image forming apparatus) instructs each user having the HMD 1 mounted thereon to direct the sight line toward the AR marker. At this time point, the image capturing part 12 is performing image capture. Thus, an image of the AR marker is captured by the image capturing part 12.

Subsequent to image capture of the AR marker by the image capturing part 12, the HMD control part 14 performs processing related to the sales promotion or instructive training (processing in aid for the sales promotion or instructive training). In other words, the HMD control part 14 performs an AR display process of displaying a virtual image forming apparatus by using the AR technique.

A flow of the AR display process that the HMD control part 14 first performs will be described below with reference to a flowchart shown in FIG. 2.

At a start time in the flowchart of FIG. 2, it is assumed that the image capturing part 12 has captured an image of the AR marker. When the HMD control part 14 has detected the AR marker from captured image data captured by the image capturing part 12, the flowchart of FIG. 2 starts up.

At step S1, the HMD control part 14 recognizes various types of information buried in the AR marker. Identification information indicative of an apparatus type corresponding to a virtual image forming apparatus to be displayed is buried in the AR marker. Therefore, in this case, the identification information is recognized by the HMD control part 14.

At step S2, in order to acquire display data of the virtual image forming apparatus, the HMD control part 14 transmits a transmission request to the server 2 by using the HMD communication part 16. In the transmission request for the server 2, the identification information recognized by the process of step S1 is included.

The server 2, having received the transmission request (including identification information), extracts fundamental display data from the display data information DD (information including plural pieces of display data corresponding to one apparatus type) corresponding to the apparatus type indicated by the received identification information. Then, the server 2 transmits the fundamental display data to the HMD 1.

For example, included in the plural display data corresponding to one apparatus type (plural display data corresponding to plural apparatus statuses, respectively) are: display data for virtually displaying a status in which the real machine is executing a job (i.e., a status in which the machine is conveying and discharging a sheet); display data for virtually displaying a status in which a sheet cassette (corresponding to ‘movable member’) set in the real machine is being moved from an initial position (i.e., a status of being pulled out); display data for virtually displaying a status in which a document conveyance unit (corresponding to ‘movable member’) set in the real machine is being moved from its initial position (i.e., a status of being opened); and the like. From among these display data, the fundamental display data is given by display data for virtually displaying the real machine in a fundamental status in which the real machine is executing no job and in which such movable members as the document conveyance unit and the sheet cassette are set in their initial positions, respectively.

When the HMD communication part 16 has received fundamental display data transmitted from the server 2, the HMD control part 14, at step S3, instructs the display part 11 to display a virtual image forming apparatus (AR image) based on the fundamental display data. The display part 11, while allowing a user to discern the real space (inside of the demonstration site), displays the virtual image forming apparatus in overlay on the real space.

In this aspect, based on the captured image data captured by the image capturing part 12, the HMD control part 14 recognizes a position (coordinates) of the AR marker within a display area of the display part 11. Then, the HMD control part 14 controls the display part 11 so that the virtual image forming apparatus is displayed at the recognized position.

Also, based on the captured image data captured by the image capturing part 12, the HMD control part 14 recognizes an orientation of the AR marker within the display area of the display part 11. Then, the HMD control part 14 controls the display of the virtual image forming apparatus by the display part 11 so that the recognized orientation and the orientation of the virtual image forming apparatus become congruous with each other.

Also based on the captured image data captured by the image capturing part 12, the HMD control part 14 recognizes a size of the AR marker within the display area of the display part 11. Then, based on the recognized size, the HMD control part 14 controls the display of the virtual image forming apparatus by the display part 11 so that the virtual image forming apparatus becomes equal in size to the real machine as viewed from the user.

Although not particularly limited, the AR marker is given by the QR code (registered trademark), and the HMD control part 14 recognizes position, orientation and size of the AR marker within the display area of the display part 11 by depending on the position, orientation and size of symbols present at three corners in the AR marker. In other words, by depending on the position, orientation and size of the symbols present at three corners in the AR marker, the HMD control part 14 sets the position, orientation and size of the virtual image forming apparatus to be displayed on the display part 11.

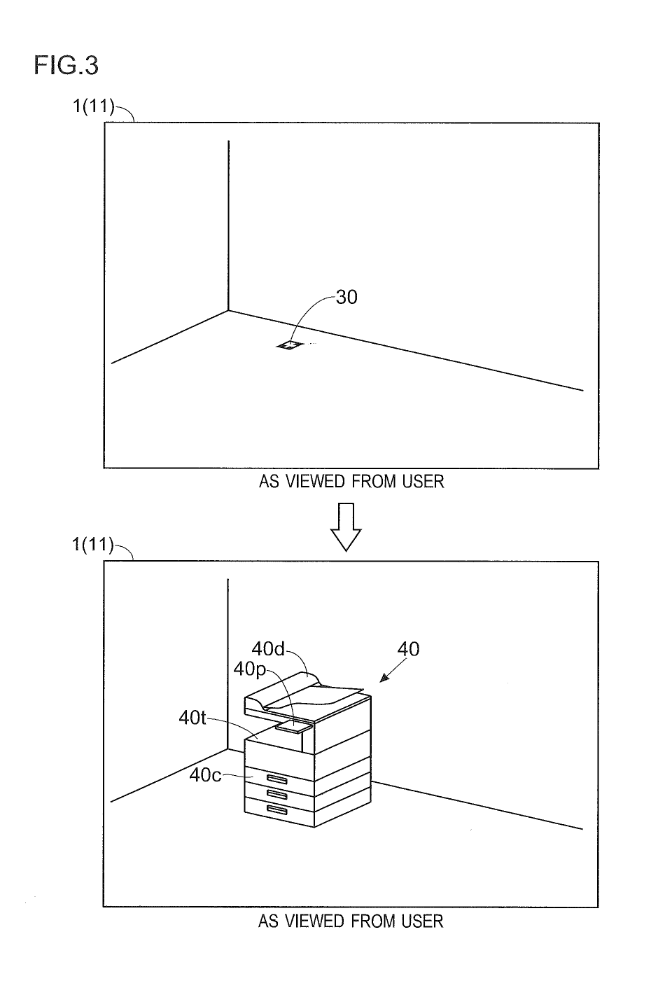

For example, as shown in the upper view of FIG. 3, it is assumed that the AR marker is provided in a specified region within the demonstration site. In the upper view of FIG. 3, the AR marker is denoted by reference sign 30. While the HMD 1 is out of the AR display process, it looks to the user that the real machine is not installed in the specified region.

Then, as shown in the lower view of FIG. 3, when the AR display process by the HMD 1 is executed, the virtual image forming apparatus is displayed on the HMD 1. In the lower view of FIG. 3, the virtual image forming apparatus is denoted by reference sign 40. With the HMD 1 displayed by the HMD 1, although the real machine is not installed in the specified region, it looks to the user as if the real machine were installed in the specified region.

The lower view of FIG. 3 shows a case, as an example, in which the real machine modeling for the virtual image forming apparatus 40 is a multifunction peripheral. In this multifunction peripheral, a sheet cassette for containing paper sheets therein is set up in a settable/removable fashion, and moreover a document conveyance unit for conveying an original document is set up in an openable/closable fashion. Then, the multifunction peripheral conveys and discharges a sheet (paper or document) in execution of a job.

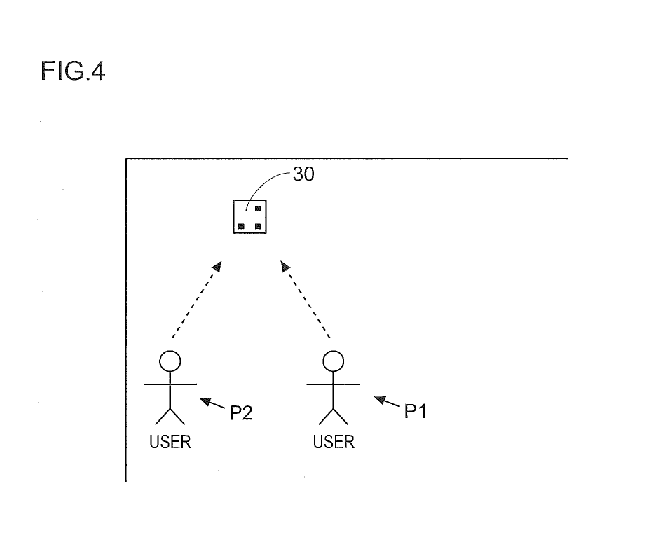

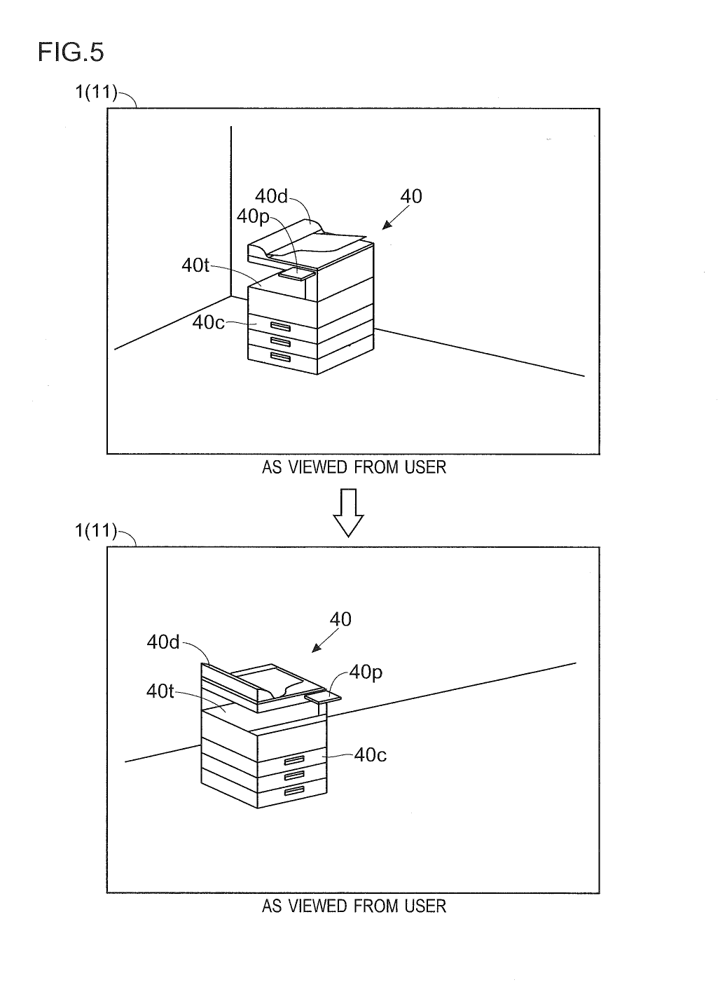

For example, with the virtual image forming apparatus 40 displayed in an orientation shown in the lower view of FIG. 3, assume that a user has moved from a position P1 to a position P2 as shown in FIG. 4. That is, it is assumed that the user has moved rightward. It is noted that the user's sight-line direction is depicted by broken-line arrows in FIG. 4.

In this case, the orientation of the AR marker 30 in the display area of the display part 11 is changed. Accordingly, the HMD control part 14 resets the orientation of the virtual image forming apparatus 40 so that the orientation of the AR marker 30 and the orientation of the virtual image forming apparatus 40 become congruous with each other. As a result, the orientation of the virtual image forming apparatus 40 displayed on the HMD 1 is changed from a status shown in the upper view of FIG. 5 (corresponding to lower view of FIG. 3) to another status shown in the lower view of FIG. 5.

In addition, it is also allowable that at least one of the display position, display orientation (display angle) and display size of the virtual image forming apparatus 40 can be arbitrarily changed. For example, three gesture operations are predetermined in correspondence to a position-changing operation for changing the display position, an orientation-changing operation for changing the display orientation, and a size-changing operation for changing the display size, respectively. When the user has made, before the user's eyes, a gesture operation corresponding to any one of the changing operations, the gesture operation made by the user is captured as an image by the image capturing part 12. Based on captured image data captured by the image capturing part 12, the HMD control part 14 detects the gesture operation made by the user, then deciding which operation the user has made out of the position-changing operation, the display-orientation changing operation, and the size-changing operation.

The display part 11 displays, for example, button images (virtual buttons) for accepting individual changing operations. Then, the HMD control part 14 accepts, as a changing operation, a gesture operation made for a relevant button image (e.g., an operation of virtually tapping the relevant button image).

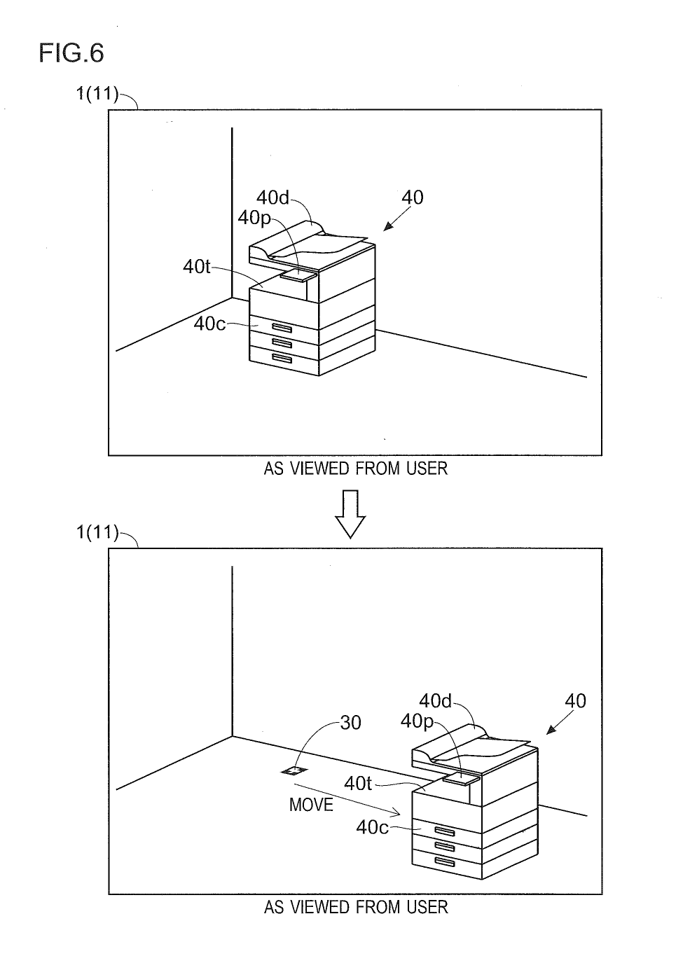

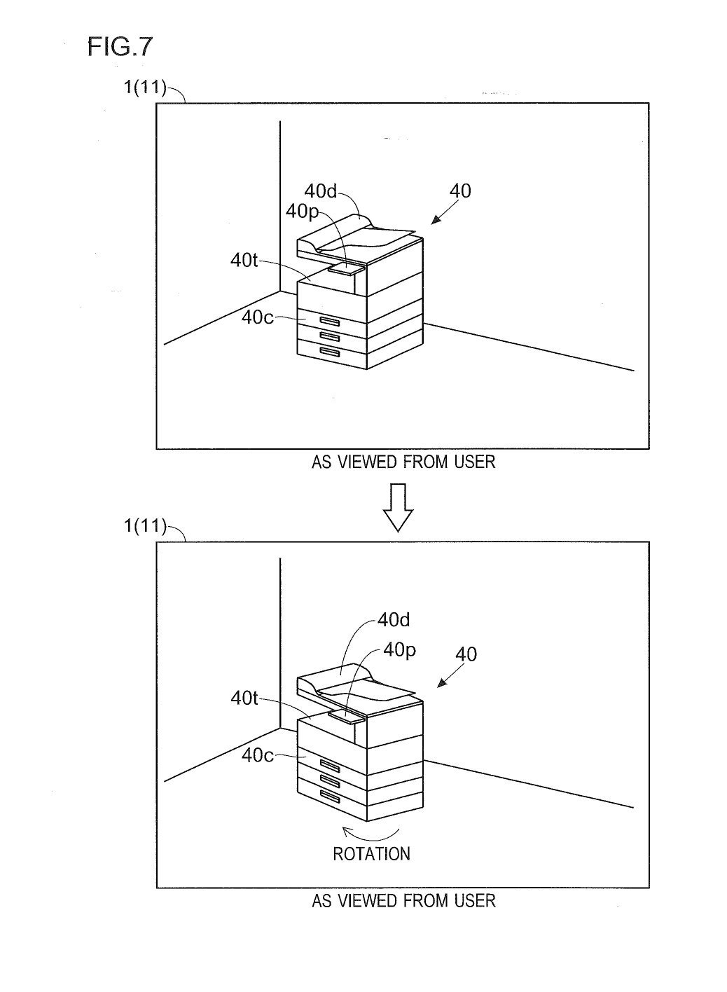

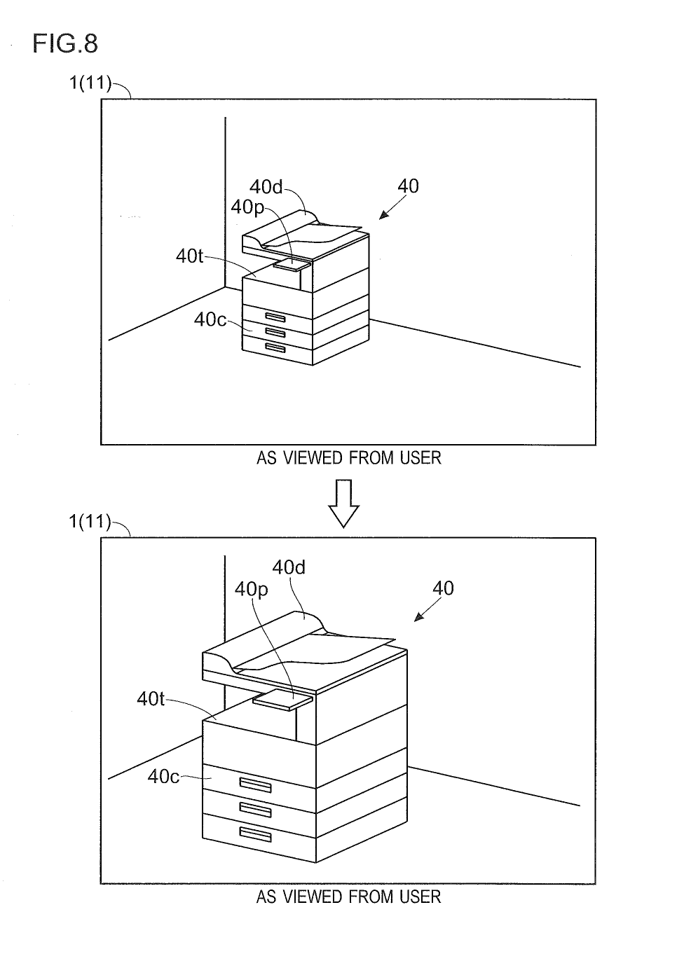

When deciding that the user has made a position-changing operation, the HMD control part 14, as shown in FIG. 6, instructs the display part 11 to execute a process of moving the virtual image forming apparatus 40. When deciding that the user has made an orientation-changing operation, the HMD control part 14, as shown in FIG. 7, instructs the display part 11 to execute a process of turning the virtual image forming apparatus 40. When deciding that the user has made a size-changing operation, the HMD control part 14, as shown in FIG. 8, instructs the display part 11 to execute a process of scaling up (or scaling down) the virtual image forming apparatus 40. For example, when a specified time has elapsed after acceptance of the changing operation, the HMD control part 14 restores the virtual image forming apparatus 40 to its status before the change. Otherwise, when detecting that a predetermined restoration operation (which may be a gesture operation or an operation made for the operation part 13) has been made, the HMD control part 14 restores the virtual image forming apparatus 40 to its status before the change.

### Virtual Operation for the Virtual Image Forming Apparatus

While the HMD 1 is displaying the virtual image forming apparatus, the user is allowed to virtually operate the virtual image forming apparatus. In other words, the user is allowed to make an operation request of requesting an operation for the virtual image forming apparatus. When the user has made an operation request, the status of the virtual image forming apparatus is changed to another in which an operation of the user's request has been made for the virtual image forming apparatus.

For example, predetermined gesture operations are correspondingly associated with operation requests, respectively. Information indicative of correspondence relation between gesture operations and operation requests is stored in the HMD storage part 15. When detecting that the user has made a gesture operation corresponding to an operation request, the HMD control part 14 accepts the detected gesture operation as an operation request. Then, the HMD control part 14 instructs the display part 11 to make a display change from one virtual image forming apparatus that is currently being displayed to another virtual image forming apparatus that has been subjected to an operation of the user's request (i.e., an operation requested by the operation request accepted from the user). It is noted that there are a plurality of operations that can be virtually executed for the virtual image forming apparatus (i.e., operations that can be requested by operation request).

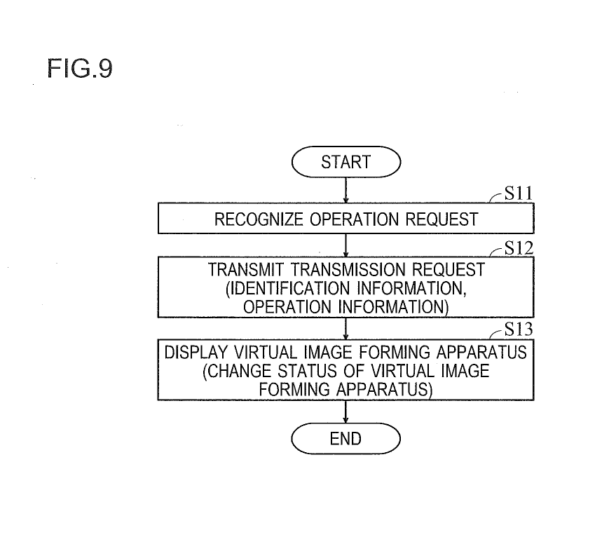

Hereinbelow, a flow of the AR display process to be executed by the HMD control part 14 after the display part 11 has started to display the virtual image forming apparatus based on the fundamental display data will be described with reference to a flowchart shown in FIG. 9.

At a start time in the flowchart of FIG. 9, it is assumed that the display part 11 is displaying a virtual image forming apparatus based on the fundamental display data. After this on, a user who wants to virtually operate the virtual image forming apparatus makes a gesture operation before the user's eyes. A gesture operation made by the user in this case is captured as an image by the image capturing part 12, and captured image data acquired by this image capture is outputted to the HMD control part 14. Based on the captured image data captured by the image capturing part 12, the HMD control part 14 decides whether or not the user has made a gesture operation corresponding to any one operation request. As a result, when the HMD control part 14 decides that the user has made a gesture operation corresponding to one operation request, the flowchart shown in FIG. 9 starts up.

At step S11, the HMD control part 14 recognizes an operation request corresponding to the gesture operation made by the user. In other words, the HMD control part 14 recognizes which operation the user has virtually made for the virtual image forming apparatus.

At step S12, the HMD control part 14 adds, to a transmission request, operation information indicative of an operation requested by the operation request recognized by the process of step S11 (i.e., an operation virtually made for the virtual image forming apparatus by the user). Also added to the transmission request is identification information indicative of an apparatus type corresponding to the virtual image forming apparatus that is currently being displayed (virtual image forming apparatus virtually operated by the user). Then, the HMD control part 14 transmits the transmission request including the identification information and the operation information to the server 2 by using the HMD communication part 16.

The server 2, having received the transmission request (including the identification information and the operation information), extracts display data corresponding to the received operation information from display data information DD corresponding to the received identification information. Then, the server 2 transmits the extracted display data to the HMD 1. In this process, a communication status between the HMD 1 and the server 2 may also be confirmed based on a packet loss factor which is determined from response packets responding to ping packets. Under an unfavorable communication status, the display data is retransmitted from the server 2 to the HMD 1.

When the HMD communication part 16 has received the display data transmitted from the server 2, the HMD control part 14, at step S13, instructs the display part 11 to display a virtual image forming apparatus (AR image) based on the display data. The display part 11, while allowing the user to discern the real space (inside of the demonstration site), displays the virtual image forming apparatus based on the display data in overlay on the real space.

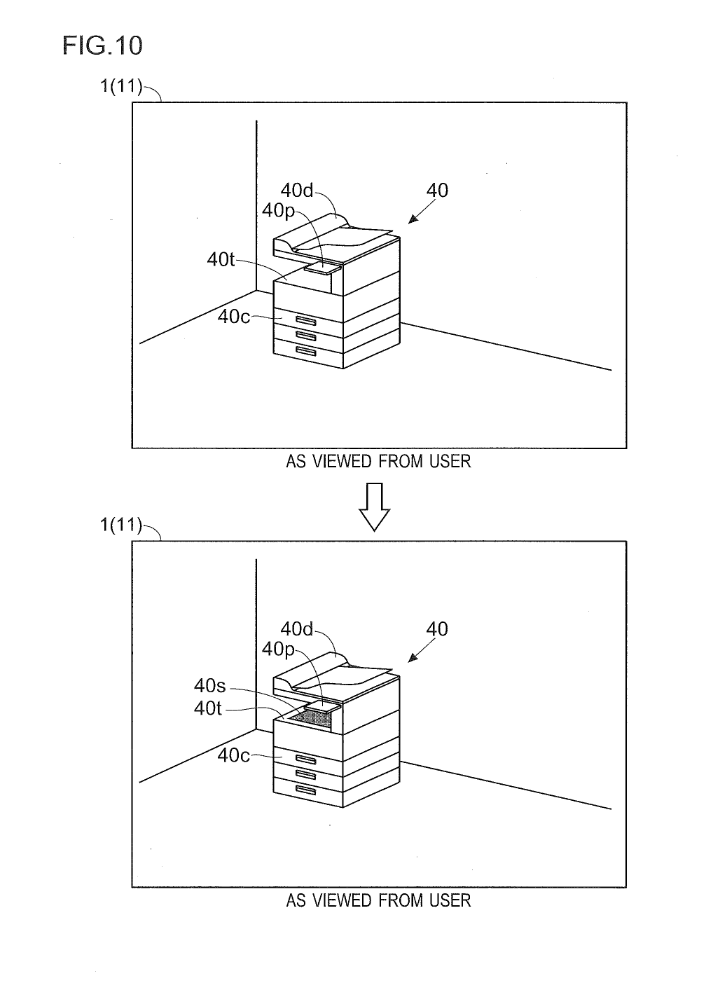

For example, assume that the user has made an operation request while the virtual image forming apparatus 40 shown in the lower view of FIG. 3 is displayed on the HMD 1. Further assume that an operation requested by the operation request in this case (i.e., a virtual operation made by the user for the virtual image forming apparatus 40) is a start operation for instructing execution of a job. In this case, the status of the virtual image forming apparatus 40 displayed on the HMD 1 is changed from a status shown in the upper view of FIG. 10 (corresponding to lower view of FIG. 3) to another status shown in the lower view of FIG. 10.

More specifically, given that the operation requested by the operation request from the user is a start operation, display data of the virtual image forming apparatus 40 in a job-executing status in which a job is being executed (i.e., display data of the job-executing status) is transmitted from the server 2 to the HMD 1. The display data of the job-executing status is display data which includes an AR image of a virtual sheet 40s simulating a sheet discharged from the corresponding real machine (e.g., a printed sheet) and which is for displaying the virtual image forming apparatus 40 that is conveying and discharging the virtual sheet 40s.

When the HMD communication part 16 has received the display data of the job-executing status, the HMD control part 14 instructs the display part 11 to make an AR display based on the display data of the job-executing status. As a result, the status of the virtual image forming apparatus 40 is changed to a status of conveying and discharging the virtual sheet 40s. That is, the HMD control part 14 instructs the display part 11 to change the status of the virtual image forming apparatus 40 to a status resulting when the operation requested by the operation request is executed.

In addition, the display data of the job-executing status is display data in animation, and the HMD control part 14 instructs the display part 11 to display an animation in which the virtual image forming apparatus 40 is conveying and discharging the virtual sheet 40s. In this case, the HMD control part 14 controls the display part 11 such that the virtual image forming apparatus 40 comes to convey and discharge the virtual sheet 40s at a speed equal to a sheet conveyance speed of the corresponding apparatus type. Although not particularly limited, in order to display the virtual image forming apparatus 40 that is seemingly conveying and discharging the virtual sheet 40s, it is also allowable that the virtual sheet 40s is placed on a virtual discharge tray 40t displayed as a part of the virtual image forming apparatus 40, and the virtual sheet 40s on the virtual discharge tray 40t is blinked at specified intervals.

For example, the HMD control part 14 accepts, as an operation request, a gesture operation given for a specified point (e.g., a point corresponding to the start key) of a virtual operation panel 40p displayed as a part of the virtual image forming apparatus 40 (e.g., an operation of seemingly tapping a specified point of the virtual operation panel 40p). Then, the HMD control part 14 recognizes that an operation corresponding to the accepted operation request is a start operation.

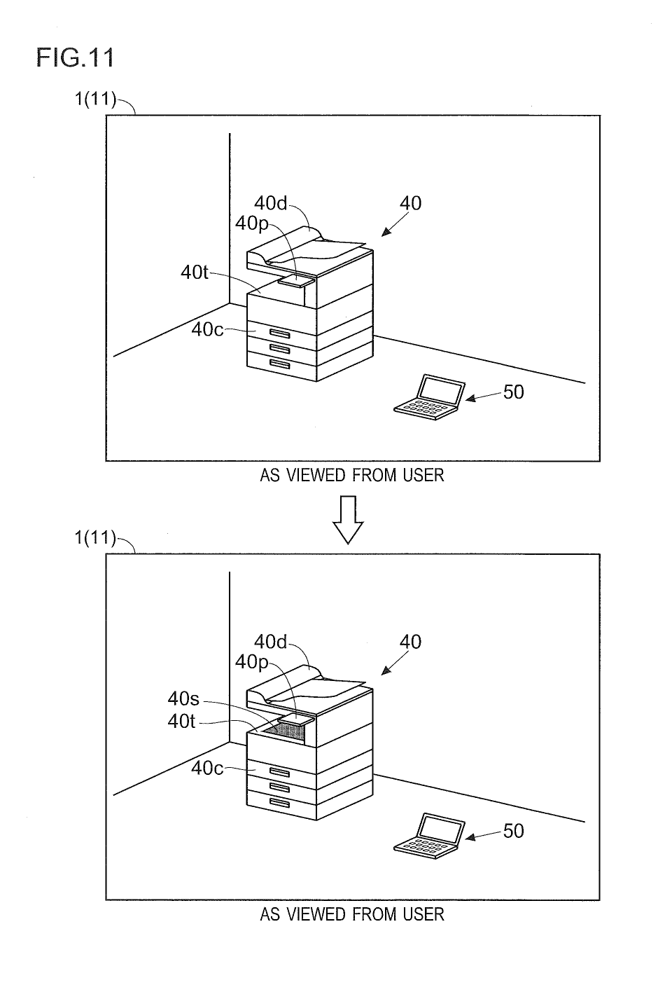

Otherwise, as shown in FIG. 11, the HMD control part 14 instructs the display part 11 to display a virtual input device 50 independent of the virtual image forming apparatus 40. The virtual input device 50 is, for example, an AR image modeled after a notebook personal computer. Then, the HMD control part 14 accepts, as an operation request, a gesture operation for a specified point (e.g., a point corresponding to the keyboard) of the virtual input device 50 (e.g., an operation of seemingly tapping a specified point of the virtual input device 50). Then, the HMD control part 14 recognizes that an operation corresponding to the accepted operation request is a start operation.

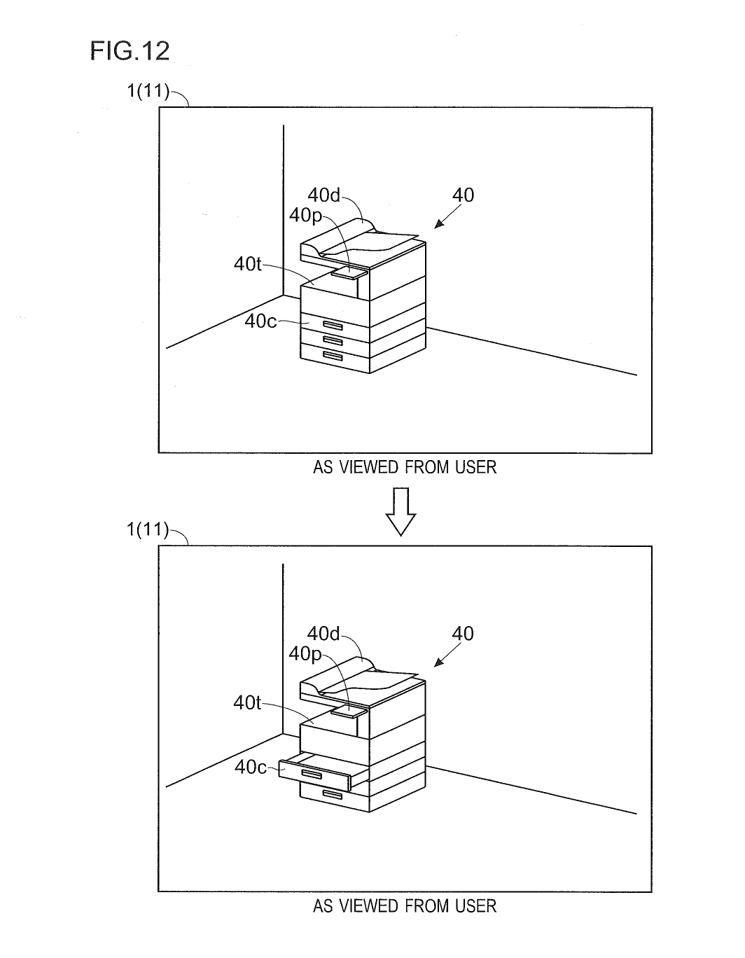

As another example, assume that the operation requested by an operation request from the user is a pulling-out operation of pulling out a sheet cassette (corresponding to ‘moving operation’). In this case, display data of the virtual image forming apparatus 40 in a cassette-pulled out status in which the sheet cassette is being pulled out (i.e., display data of the cassette-pulled out status) is transmitted from the server 2 to the HMD 1. By execution of the AR display based on the display data of the cassette-pulled out status, the status of the virtual image forming apparatus 40 displayed on the HMD 1 is changed from a status shown in the upper view of FIG. 12 (corresponding to lower view of FIG. 3) to another status shown in the lower view of FIG. 12. That is, the virtual image forming apparatus 40 in the cassette-pulled out status is displayed on the HMD 1.

For example, the HMD control part 14 accepts, as an operation request, a gesture operation for a virtual sheet cassette 40c (e.g., an operation of moving a hand back and forth). Then, the HMD control part 14 recognizes that an operation corresponding to the accepted operation request is a pulling-out operation.

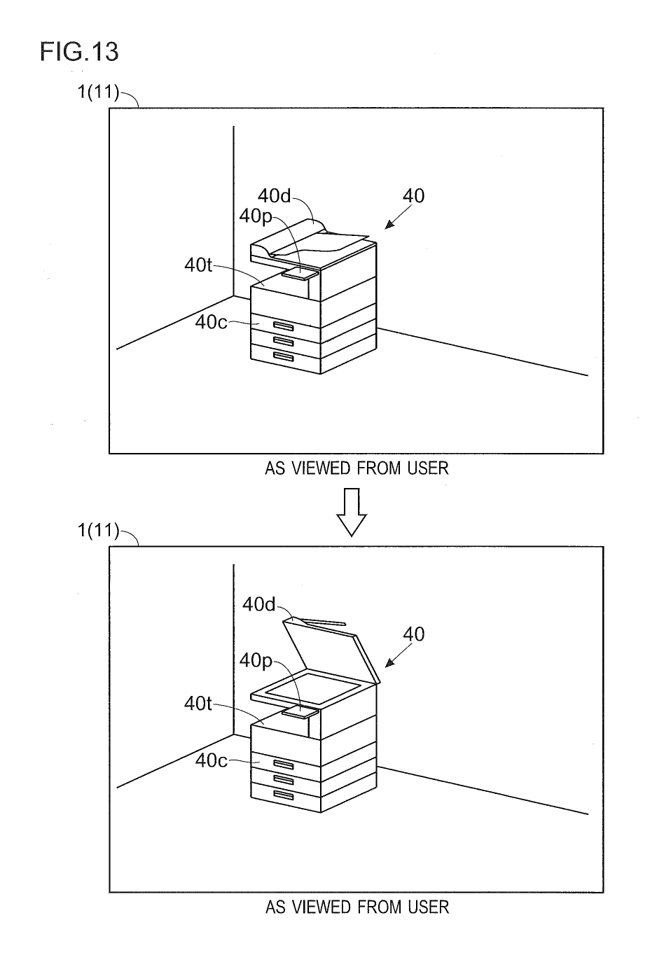

As yet another example, assume that the operation requested by an operation request from the user is an opening operation of opening the document conveyance unit (corresponding to ‘moving operation’). In this case, display data of the virtual image forming apparatus 40 in a unit-opened status in which the document conveyance unit is being opened (i.e., display data of the unit-opened status) is transmitted from the server 2 to the HMD 1. By execution of the AR display based on the display data of the unit-opened status, the status of the virtual image forming apparatus 40 displayed on the HMD 1 is changed from a status shown in the upper view of FIG. 13 (corresponding to lower view of FIG. 3) to another status shown in the lower view of FIG. 13. That is, the virtual image forming apparatus 40 in the unit-opened status is displayed on the HMD 1.

For example, the HMD control part 14 accepts, as an operation request, a gesture operation for a virtual document conveyance unit 40d (e.g., an operation of moving a hand up and down). Then, the HMD control part 14 recognizes that an operation corresponding to the accepted operation request is an opening operation.

As described above, the HMD 1 (display device) of this embodiment includes the display part 11 for displaying in overlay the virtual image forming apparatus 40 on the real space while allowing the user to discern the real space, and the HMD control part 14 (controller) for controlling the display part 11. When receiving an operation request of requesting an operation for the virtual image forming apparatus 40, the HMD control part 14 instructs the display part 11 to change a status of the virtual image forming apparatus 40 to a status resulting when the operation requested by the operation request is executed.

With this configuration, when the user has made an operation request, the status of the virtual image forming apparatus 40 is changed to a status resulting when the operation requested by the operation request is executed. Thus, the user is allowed to know which status the real machine is thrown to by the operation requested by the operation request. Accordingly, on occasions when an explanation is performed on an image forming apparatus, the explanation on the image forming apparatus can be fulfilled with high efficiency even in the absence of the real machine.

Also in this embodiment, as described above, when an operation requested by the operation request is a start operation, the HMD control part 14 changes the status of the virtual image forming apparatus 40 to a status in which the virtual image forming apparatus 40 is conveying and discharging the virtual sheet 40s. In this case, the HMD control part 14 controls the display part 11 such that the virtual image forming apparatus 40 comes to a status of conveying and discharging the virtual sheet 40s at a speed equal to a sheet conveyance speed of the real machine modeling for the virtual image forming apparatus 40. With this feature, the user is allowed to confirm the performance (printing speed) of the real machine. In other words, the user is allowed to confirm the productivity resulting when the real machine is installed (purchased).

Also in this embodiment, as described above, the HMD control part 14 instructs the display part 11 to display the virtual operation panel 40p as a part of the virtual image forming apparatus 40; then, upon detecting based on captured image data captured by the image capturing part 12 that a gesture operation for the virtual operation panel 40p has been made, accepts the detected gesture operation as an operation request; and moreover recognizes that an operation requested by the accepted operation request is a start operation. Otherwise, the HMD control part 14 instructs the display part 11 to display the virtual input device 50 independent of the virtual image forming apparatus 40; then, upon detecting based on captured image data captured by the image capturing part 12 that a gesture operation for the virtual input device 50 has been made, accepts the detected gesture operation as an operation request; and moreover recognizes that an operation requested by the accepted operation request is a start operation. Normally, making an operation for an operation panel provided on the real machine or for an input device connected to the real machine causes a job to be executed by the real machine. Therefore, with this apparatus configuration, it becomes easier to understand which operation should be made when it is desired to change the status of the virtual image forming apparatus 40 to the job-executing status.

Also in this embodiment, as described above, the HMD control part 14 instructs the display part 11 to display, as a part of the virtual image forming apparatus 40, a virtual sheet cassette 40c (virtual movable member) corresponding to a sheet cassette (movable member) of the real machine modeling for the virtual image forming apparatus 40; and then, given that an operation requested by the operation request is a pulling-out operation (moving operation), changes the status of the virtual image forming apparatus 40 to a cassette-pulled out status (a status in which the virtual movable member is moved). Furthermore, the HMD control part 14 instructs the display part 11 to display, as a part of the virtual image forming apparatus 40, a virtual document conveyance unit 40d (virtual movable member) corresponding to a document conveyance unit (movable member) of the real machine modeling for the virtual image forming apparatus 40; and then, given that an operation requested by the operation request is an opening operation (moving operation), changes the status of the virtual image forming apparatus 40 to a unit-opened status (a status in which the virtual movable member has been moved). With this feature, the user is allowed to know a status of the real machine in which the sheet cassette has been pulled out, or a status of the real machine in which the document conveyance unit has been opened.

Also in this embodiment, as described above, based on position, orientation and size of the AR marker 30 (reference marker) captured by the image capturing part 12, the HMD control part 14 sets position, orientation and size of the virtual image forming apparatus 40 to be displayed on the display part 11. In this case, the HMD control part 14 sets the size of the virtual image forming apparatus 40 such that the virtual image forming apparatus 40 becomes equal in size to the real one as viewed from the user. With this feature, it is possible to confirm the size of the real machine. For example, it is possible to confirm whether or not the real machine can be installed at an installation site of a user's desire, or to confirm an atmosphere resulting when the real machine is installed.

### Process for Cases Where Plural Virtual Image Forming Apparatuses are Displayed

The number of AR markers to be provided in a demonstration site where sales promotion or instructive training is carried out is not particularly limited. In one demonstration site, a plurality of AR markers 30 may be provided.

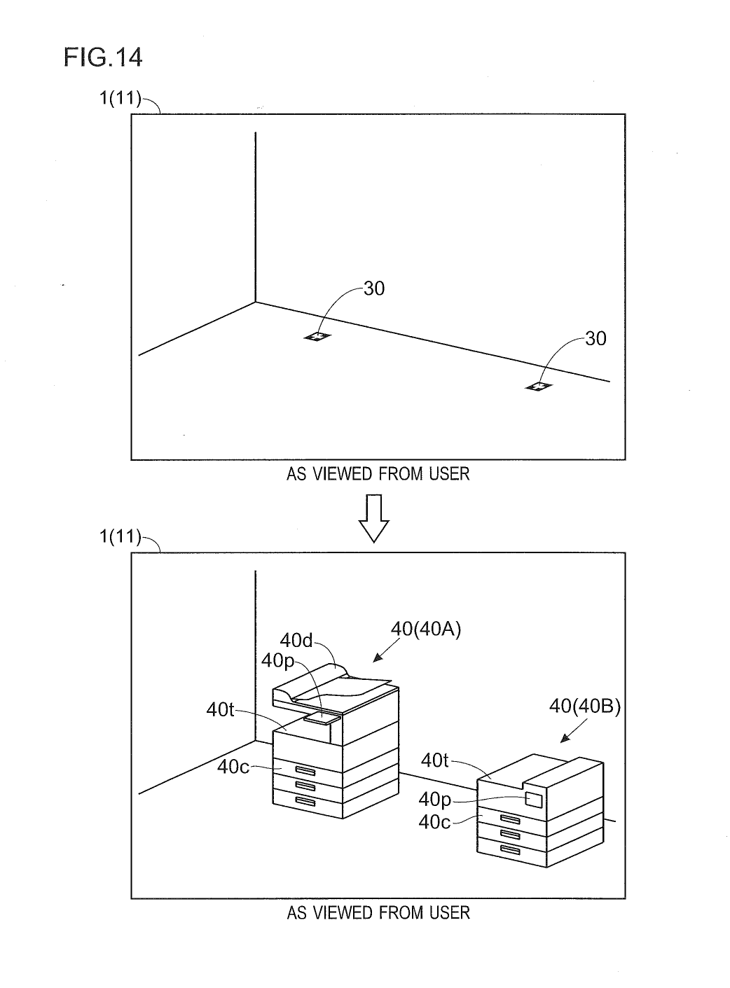

For example, as shown in an upper view of FIG. 14, assume that, in a demonstration site where a plurality of AR marker 30 are provided, a user with the HMD 1 set thereon has directed the sight line toward the plural AR markers 30, so that the image capturing part 12 has captured an image of the plural AR markers 30. In this case, as shown in a lower view of FIG. 14, the HMD control part 14 instructs the display part 11 to display the plural virtual image forming apparatuses 40. It is noted that apparatus types corresponding to the plural virtual image forming apparatuses 40, respectively, may be identical or different with each other or one another. The lower view of FIG. 14 shows a case in which two virtual image forming apparatuses 40A and 40B corresponding to mutually different two apparatus types are displayed. A real machine corresponding to the virtual image forming apparatus 40A is a multifunction peripheral equipped with scan function and print function, and a real machine corresponding to the virtual image forming apparatus 40B is a printer equipped with no scan function.

Then, it is assumed that while the display part 11 is displaying the plural virtual image forming apparatuses 40, the HMD control part 14 decides that an operation request has been accepted from a user. In this case, the HMD control part 14 instructs the display part 11 to change individual statuses of the plural virtual image forming apparatuses 40 to statuses each resulting when an operation requested by the operation request is executed.

As an example, it is assumed that an operation request has been made under the state shown in the lower view of FIG. 14. It is also assumed that an operation requested by the operation request is a start operation.

In this case, the HMD control part 14 transmits, to the server 2, a transmission request including operation information indicative of an operation requested by the operation request, identification information (here is added sign A) as to an apparatus type corresponding to the virtual image forming apparatus 40A, and identification information (here is added sign B) as to an apparatus type corresponding to the virtual image forming apparatus 40B. As a result, display data of the job-executing status corresponding to the identification information A, as well as display data of the job-executing status corresponding to the identification information B are transmitted from the server 2 to the HMD 1.

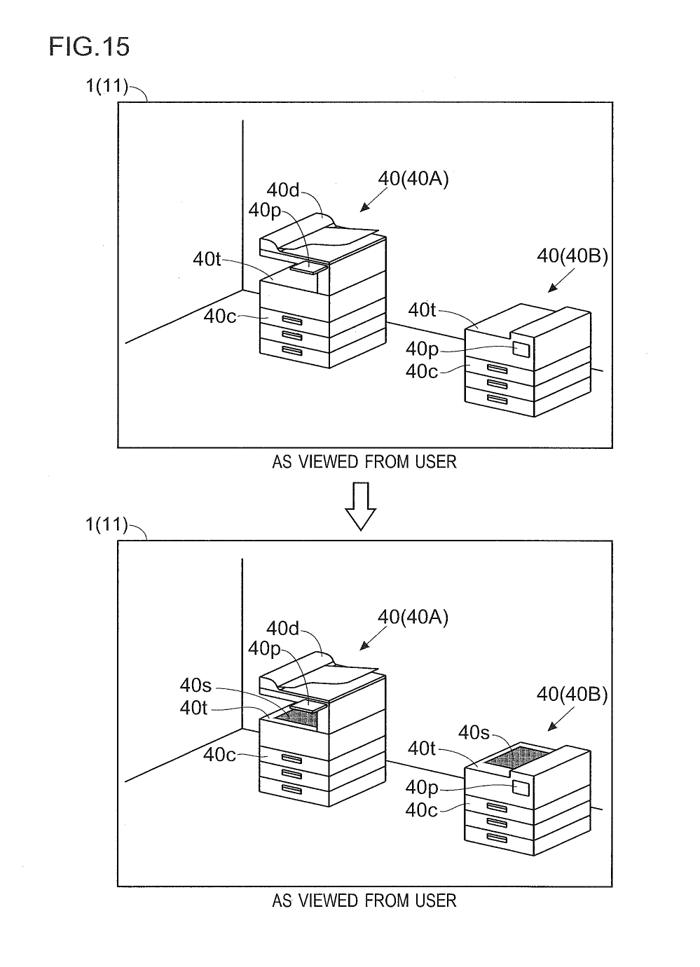

Thus, individual statuses of the virtual image forming apparatus 40A and the virtual image forming apparatus 40B displayed on the HMD 1 are changed from statuses shown in an upper view of FIG. 15 (corresponding to lower view of FIG. 14) to statuses shown in a lower view of FIG. 15, respectively. That is, the status of the virtual image forming apparatus 40A is changed to a status of conveying and discharging the virtual sheet 40s, and similarly, the status of the virtual image forming apparatus 40B is also changed to a status of conveying and discharging the virtual sheet 40s.

With this feature, making a gesture operation (operation request) only once allows all the statuses of the plural virtual image forming apparatuses 40 to be changed collectively, hence enhanced convenience for the user.

In addition, before accepting an operation request, the HMD control part 14 accepts, from the user, a selection of a virtual image forming apparatus 40 targeted for the operation request out of the plural virtual image forming apparatuses 40. Upon accepting the selection, the HMD control part 14 instructs the display part 11 to change the status of only a virtual image forming apparatus 40 selected out of the plural virtual image forming apparatuses 40 to a status resulting when the operation requested by the operation request is executed.

Assume that in the state shown in the lower view of FIG. 14, as an example, the virtual image forming apparatus 40A is selected out of the plural virtual image forming apparatuses 40, and an operation request is executed. Also assume that the operation requested by the operation request is a start operation.

In this case, the HMD control part 14 transmits, to the server 2, a transmission request including operation information indicative of an operation requested by the operation request, and the identification information A as to an apparatus type corresponding to the virtual image forming apparatus 40A. As a result, display data of the job-executing status corresponding to the identification information A is transmitted from the server 2 to the HMD 1.

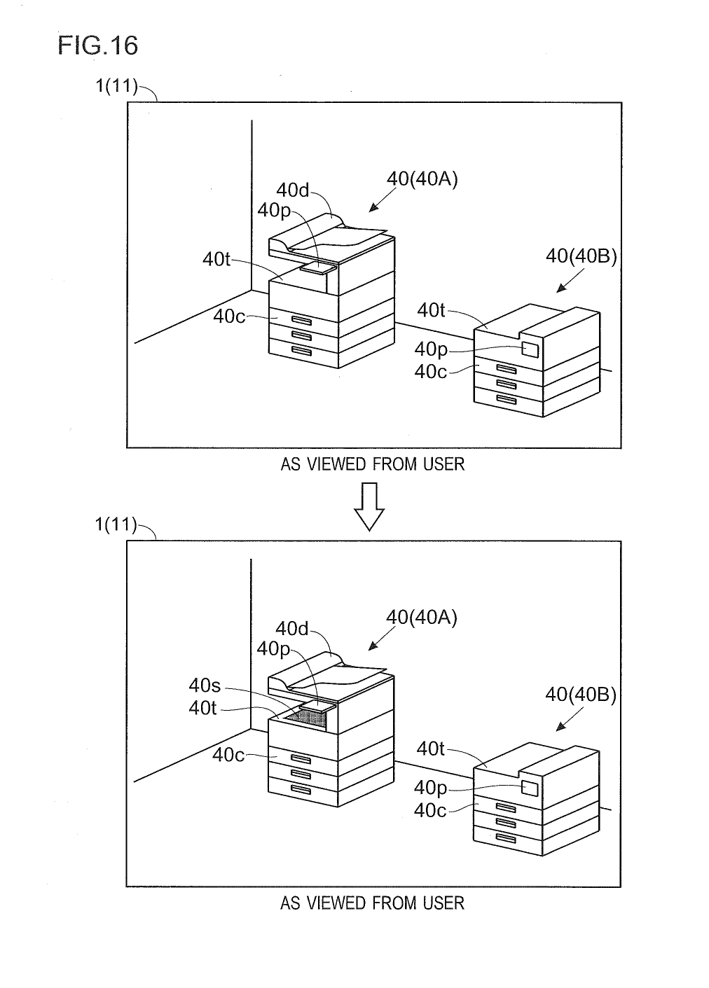

Thus, the status of the virtual image forming apparatus 40A displayed on the HMD 1 is changed from a status shown in an upper view of FIG. 16 (corresponding to lower view of FIG. 14) to another status shown in a lower view of FIG. 16. That is, the status of the virtual image forming apparatus 40A is changed to a status of conveying and discharging the virtual sheet 40s. Meanwhile, there is provided no display data for displaying the virtual image forming apparatus 40B in the status of conveying and discharging the virtual sheet 40s. Accordingly, the status of the virtual image forming apparatus 40B is not changed.

With this feature, even with plural virtual image forming apparatuses 40 displayed on the HMD 1, it is possible to selectively change the status of only any one of the virtual image forming apparatuses 40, hence enhanced convenience for the user.

In the example shown in the lower view of FIG. 14, the apparatus type (multifunction peripheral) corresponding to the virtual image forming apparatus 40A is equipped with the scan function while the apparatus type (printer) corresponding to the virtual image forming apparatus 40B is not equipped with the scan function. In this case, even when an operation request related to the scan function (corresponding to ‘specified function’) is made, the status of the virtual image forming apparatus 40B is not changed. The status of the virtual image forming apparatus 40A is changed to a status resulting when an operation requested by the operation request is executed.

As an example, assume that in the state shown in the lower view of FIG. 14, an operation request related to the scan function has been executed. An operation requested by the operation request related to the scan function is, for example, an opening operation (an operation of opening the document conveyance unit).

In this case, the HMD control part 14 transmits a transmission request which includes operation information indicative of an opening operation being the operation requested by the operation request, the identification information A as to the apparatus type corresponding to the virtual image forming apparatus 40A, and the identification information B as to the apparatus type corresponding to the virtual image forming apparatus 40B. On one hand, plural display data corresponding to the identification information A include display data corresponding to the operation information indicative of the opening operation (display data of the unit-opened status). On the other hand, plural display data corresponding to the identification information B include no display data corresponding to the operation information indicative of the opening operation. Accordingly, only the display data of the unit-opened status corresponding to the identification information A is transmitted from the server 2 to the HMD 1.

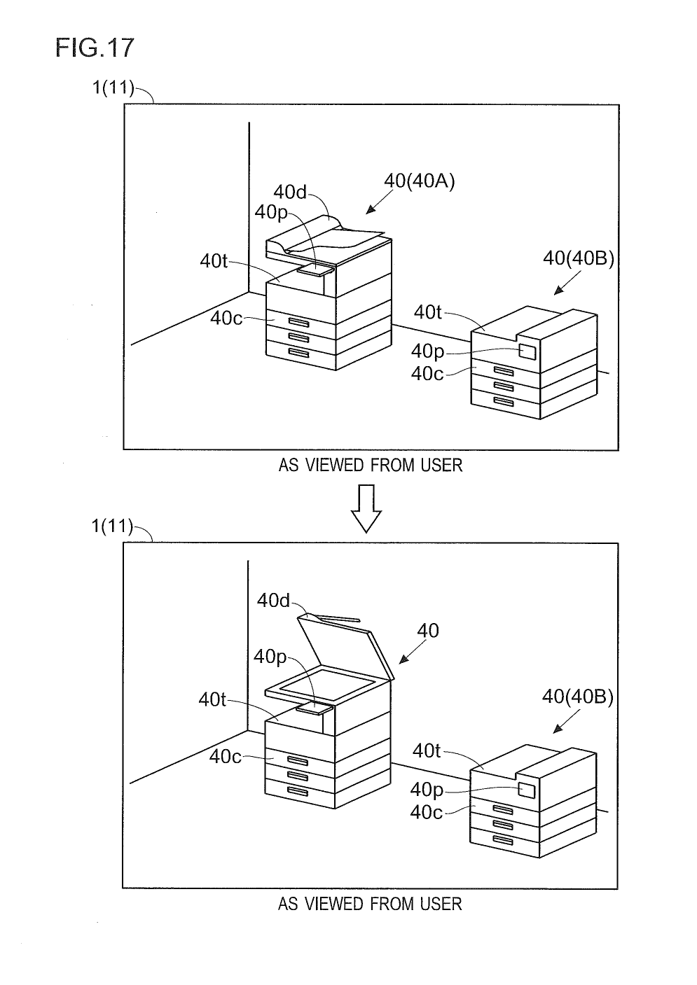

Thus, the status of the virtual image forming apparatus 40A displayed on the HMD 1 is changed from a status shown in an upper view of FIG. 17 (corresponding to lower view of FIG. 14) to another status shown in a lower view of FIG. 17. That is, the status of the virtual image forming apparatus 40A is changed to a status in which the virtual document conveyance unit 40d of the virtual image forming apparatus 40A has been opened. Meanwhile, the status of the virtual image forming apparatus 40B is not changed.

### Process for Cases Where Plural HMDs are Used

For example, with plural instruction trainees present, each of the plural instruction trainees has the HMD 1 mounted thereon. That is, plural users of the HMD 1 are involved. Further, an explainer also has the HMD 1 mounted thereon (the explainer is also a user of the HMD 1). With plural HMDs 1 used like this, when the status of a virtual image forming apparatus displayed on any one of the HMDs 1 is changed, statuses of virtual image forming apparatuses displayed on the other HMDs 1 can also be changed similarly.

For example, assume that the virtual image forming apparatus 40 as shown in the upper view of FIG. 10 is displayed on the HMDs 1 of the individual users. Then, assume that one user has made an operation request in this state. Also assume that an operation requested by the operation request from the user is a start operation. Hereinafter, the HMD 1 that has accepted the operation request will be referred to as request-accepting HMD 1.

The HMD control part 14 of the request-accepting HMD 1 transmits, to the server 2, a transmission request including operation information indicative of the operation requested by the operation request, and identification information as to an apparatus type corresponding to the virtual image forming apparatus 40.

Having received the transmission request, the server 2, based on the received identification information, recognizes HMDs 1 (hereinafter, referred to as synchronization-object HMDs 1) that are currently displaying the same virtual image forming apparatus 40 as that of the request-accepting HMD 1. For example, each HMD 1 transmits, to the server 2, identification information as to an apparatus type corresponding to a virtual image forming apparatus 40 that is currently displayed. Accordingly, the server 2 is enabled to recognize the synchronization-object HMDs 1 based on the identification information received from the individual HMDs 1.

To the request-accepting HMD 1 and all of the synchronization-object HMDs 1, the server 2 transmits display data corresponding to the received operation information. As a result of this, the status of the virtual image forming apparatus 40 displayed on the request-accepting HMD 1 is changed, and the statuses of the virtual image forming apparatuses 40 displayed on the synchronization-object HMDs 1 are also changed similarly. That is, the request-accepting HMD 1 and the synchronization-object HMDs 1 each display such a virtual image forming apparatus 40 as shown in the lower view of FIG. 10.

With this feature, for example, in a case where one explainer gives an explanation as to an image forming apparatus to plural instruction trainees, the explainer's making a gesture operation (operation request) only once allows the virtual image forming apparatuses 40 displayed on all the HMDs 1 of the plural instruction trainees to be changed to a status resulting when the operation requested by the operation request is executed. Thus, higher convenience results.

The embodiment disclosed herein should be construed as not being limitative but being an exemplification at all points. The scope of the invention is defined not by the above description of the embodiment but by the appended claims, including all changes and modifications equivalent in sense and range to the claims.

For example, although the above embodiment has been described on a case where the HMD 1 and the server 2 are used, it is also allowable that functions of the server 2 are installed on the HMD 1 and the server 2 is omitted. In this case, the present invention may be implemented only by the HMD 1 (the need for communications between the HMD 1 and the server 2 is eliminated). Given a poor processing performance of the server 2, a plurality of servers 2 may be employed.

Also, although the above embodiment has been given on a case where the HMD 1 is used, smartphones or tablet computers may be used to substitute for the HMD 1.

Furthermore, in a case where spatial recognition is enabled by the HMD 1, the spatial recognition function may be utilized, instead of utilizing the AR marker 30, to make up a working configuration in which objects such as the virtual image forming apparatus 40 are arranged.

1. A display device comprising:
a display part for, while allowing a user to discern a real space, displaying in overlay a virtual image forming apparatus on the real space; and
a controller for controlling the display part, wherein
upon accepting from the user an operation request of requesting an operation for the virtual image forming apparatus, the controller instructs the display part to change a status of the virtual image forming apparatus to a status resulting when the operation requested by the operation request is executed.

2. The display device according to claim 1, wherein
the virtual image forming apparatus is modeled after an image forming apparatus which conveys and discharges a sheet in execution of a job, and
when an operation requested by the operation request is a start operation, the controller changes a status of the virtual image forming apparatus to a status in which the virtual image forming apparatus is conveying and discharging a virtual sheet.

3. The display device according to claim 2, wherein
the controller controls the display part in such a fashion that the virtual image forming apparatus comes to a status of conveying and discharging the virtual sheet at a speed equal to a sheet conveyance speed of the image forming apparatus modeling for the virtual image forming apparatus.

4. The display device according to claim 2, further comprising an image capturing part for capturing an image of a user's gesture operation, wherein
the controller instructs the display part to display a virtual operation panel as a part of the virtual image forming apparatus, and the controller, upon detecting based on captured image data captured by the image capturing part that a gesture operation for the virtual operation panel has been made, accepts the detected gesture operation as the operation request and moreover recognizes that an operation requested by the accepted operation request is the start operation.

5. The display device according to claim 2, further comprising an image capturing part for capturing an image of a user's gesture operation, wherein
the controller instructs the display part to display a virtual input device independent of the virtual image forming apparatus, and the controller, upon detecting based on captured image data captured by the image capturing part that a gesture operation for the virtual input device has been made, accepts the detected gesture operation as the operation request and moreover recognizes that an operation requested by the accepted operation request is the start operation.

6. The display device according to claim 1, wherein
the controller instructs the display part to display, as a part of the virtual image forming apparatus, a virtual movable member corresponding to a movable member of an image forming apparatus modeling for the virtual image forming apparatus, and when an operation requested by the operation request is a moving operation, the controller changes a status of the virtual image forming apparatus to a status in which the virtual movable member has been moved.

7. The display device according to claim 1, further comprising an image capturing part for capturing an image of a reference marker provided in the real space, wherein
based on position, orientation and size of the reference marker captured as an image by the image capturing part, the controller sets position, orientation and size of the virtual image forming apparatus to be displayed by the display part.

8. The display device according to claim 7, wherein the controller sets a size of the virtual image forming apparatus in such a fashion that the virtual image forming apparatus comes to its real size as viewed from the user.

9. The display device according to claim 1, wherein
the display part displays a plurality of the virtual image forming apparatuses, and
upon accepting the operation request, the controller changes individual statuses of the plural virtual image forming apparatuses displayed by the display part to a status resulting when an operation requested by the operation request is executed.

10. The display device according to claim 1, wherein
the display part displays a plurality of the virtual image forming apparatuses, and
the controller, before accepting the operation request, accepts from the user a selection of any one or ones of the virtual image forming apparatuses targeted for the operation request out of the plural virtual image forming apparatuses displayed by the display part, where when any one or ones of the virtual image forming apparatuses have been selected, the controller changes a status or statuses of only the selected virtual image forming apparatus or apparatuses to a status resulting when an operation requested by the operation request is executed.

11. The display device according to claim 1, wherein
the display part displays a first said virtual image forming apparatus modeled after an image forming apparatus equipped with a specified function, and a second said virtual image forming apparatus modeled after an image forming apparatus not equipped with the specified function, and
when an operation requested by the operation request is an operation related to the specified function, the controller changes a status of the first virtual image forming apparatus to a status resulting when the operation requested by the operation request is executed, while the controller keeps a status of the second virtual image forming apparatus from being changed.

12. A display system comprising:
a plurality of the display devices according to claim 1, wherein
when any one display device out of the plural display devices has accepted the operation request, the plural virtual image forming apparatuses change their statuses to a status resulting when an operation requested by the operation request is executed.

13. The display system according to claim 12, further comprising a server which is communicatably connected to the plural display devices, wherein
the server controls display operations performed by the plural display devices.
